(19) United States
(12) Patent Application Publication
(10) Pub. No.: US 2001/0028722 A1
(43) Pub. Date: Oct. 11, 2001

(54) Electroacoustic transducer

(76) Inventor: Kazushige Tajima, Shizuoka (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/788,510

(22) Filed: Feb. 21, 2001

(30) Foreign Application Priority Data
Feb. 29, 2000 (JP) P. 2000-054026

(51) Int. Cl. H04R 25/00; H04R 1/02

(52) U.S. Cl. 381/150; 381/345

(57) ABSTRACT

An electroacoustic transducer 1 is configured by: a base 24 made of a magnetic material; a magnetic core 22 made of a magnetic material, and upstanding on the base 24; a diaphragm 20 made of a magnetic material and supported with being separated from the tip end of the magnetic core by a gap; a magnet 25 which cooperates with the base 24, the magnetic core 22 and the diaphragm 20 to constitute a magnetic circuit, and which supplies a static magnetic field; a coil 23 wound around the magnetic core 22, and supplying an oscillating magnetic field to the magnetic circuit; and a housing 30 formed integrally with the base 24 and the magnet 25. A communication path 50 through which the back space of the diaphragm 20 communicates with the outside is formed in a side wall of the housing 30.

### BACKGROUND OF THE INVENTION

1. Field of the Invention

The present invention relates to an electroacoustic transducer which generates a sound by means of electroacoustic conversion.

2. Description of the Related Art

An electroacoustic transducer has a magnetic circuit in which a magnetic field from a magnet passes through a base member, a magnetic core, and a diaphragm and then returns to the magnet. When an oscillating electrical signal is supplied to a coil wound around the magnetic core, an oscillating magnetic field is generated by the coil and then superimposed on the static magnetic field of the magnetic circuit, and vibration of the diaphragm is transmitted to the air, thereby generating a sound.

A sound which is generated on the side of the back face of the diaphragm is opposite in phase to the sound on the side of the front face, and hence interference with the sound on the side of the front face must be suppressed as far as possible. To comply with this, the back space of the diaphragm may be hermetically sealed. In this case, the resonance frequency f0 of the diaphragm is raised by the air damping effect. As the transducer is smaller in size, the back space of the diaphragm is narrower, and hence the air damping effect exerts larger influences. In order to lower the raised resonance frequency f0, the mass of the diaphragm must be increased. In this case, however, the sound pressure level is lowered.

A technique is known in which, in order to miniaturize a transducer and increase the sound pressure level, an opening is formed in a bottom face portion of a transducer to open the back space of a diaphragm to the outside space, thereby reducing the air damping effect. In the case where such a transducer is to be mounted on a circuit board, however, it is required to configure a structure in which legs are formed on the bottom face of the transducer or a spacer or the like is interposed between the bottom face of the transducer and the circuit board in order not to close the opening of the bottom face. As a result, the mounting height of the transducer is increased.

### SUMMARY OF THE INVENTION

The invention has been made to solve the above problems, and therefore an object of the invention is to provide an electroacoustic transducer in which the mounting height can be reduced, and which is small in size and can produce a high sound pressure.

According to the invention, there is provided an electroacoustic transducer comprising:

a plate-like base member made of a magnetic material;

a magnetic core made of a magnetic material and upstanding on the base member;

a diaphragm made of a magnetic material and supported with being separated from a tip end of the magnetic core by a gap;

a magnet which cooperates with the base member, the magnetic core and the diaphragm to constitute a magnetic circuit, and which supplies a static magnetic field; and

a coil placed around the magnetic core and supplying an oscillating magnetic field to the magnetic circuit;

wherein a communication path through which a back space of the diaphragm communicates with an outside being formed in a side face portion of a body of the transducer, and the communication path passes between the base member and the magnet.

According to the invention, a communication path through which a back space of the diaphragm communicates with the outside is formed in a side face portion of the body of the transducer, and hence the communication opening is not closed even in a state where the bottom face of the transducer is closely mounted on a circuit board. As compared with a case where a communication opening is formed in the bottom face of a transducer as in the conventional art, therefore, the mounting height can be reduced.

When the magnet is placed with being separated from the base member by a predetermined distance and a communication path is disposed between them, it is possible to ensure a communication path which has a large sectional area and a small acoustic impedance. Therefore, the air damping effect in the back space of the diaphragm can be efficiently lowered, so that it is possible to realize an electroacoustic transducer which is small in size and produces a high sound pressure.

Also, according to the invention, there is provided an electroacoustic transducer comprising:

a plate-like base member made of a magnetic material;

a magnetic core made of a magnetic material and upstanding on the base member;

a diaphragm made of a magnetic material and supported with being separated from a tip end of the magnetic core by a gap;

a magnet which cooperates with the base member, the magnetic core and the diaphragm to constitute a magnetic circuit, and which supplies a static magnetic field;

a coil placed around the magnetic core and supplying an oscillating magnetic field to the magnetic circuit; and

a housing member formed integrally with the base member and the magnet;

wherein a communication path through which a back space of the diaphragm communicates with an outside being formed in a side face portion of the housing member.

According to the invention, a communication path through which the back space of the diaphragm communicates with the outside is formed in a side face portion of the housing member, and hence the communication opening is not closed even in a state where the bottom face of the transducer is closely mounted on a circuit board. As compared with a case where a communication opening is formed in the bottom face of a transducer as in the conventional art, therefore, the mounting height can be reduced.

Furthermore, the invention is characterized in that the communication path passes between the base member and the magnet.

According to the invention, the magnet is placed with being separated from the base member by a predetermined distance and a communication path is disposed between them, and hence it is possible to ensure a communication path which has a large sectional area and a small acoustic impedance. Therefore, the air damping effect in the back space of the diaphragm can be efficiently lowered, so that it is possible to realize an electroacoustic transducer which is small in size and produces a high sound pressure.

Furthermore, the invention is characterized in that the communication path passes through a cutaway portion of the magnet.

According to the invention, a cutaway portion is formed in the magnet, and the communication path is disposed so as to pass through the cutaway portion, whereby a communication path which has a large sectional area and a small acoustic impedance can be ensured. Therefore, the air damping effect in the back space of the diaphragm can be efficiently lowered, so that it is possible to realize an electroacoustic transducer which is small in size and produces a high sound pressure.

Furthermore, the invention is characterized in that the transducer further comprises a supporting member which is placed around the magnet, and which supports a peripheral edge portion of the diaphragm, and the communication path passes through a cutaway portion of the magnet and a cutaway portion of the supporting member.

According to the invention, a cutaway portion is formed in the magnet and the supporting member, and a communication path is disposed so as to pass through the cutaway portions, whereby a communication path which has a large sectional area and a small acoustic impedance can be ensured. Therefore, the air damping effect in the back space of the diaphragm can be efficiently lowered, so that it is possible to realize an electroacoustic transducer which is small in size and produces a high sound pressure.

### BRIEF DESCRIPTION OF THE DRAWINGS

FIG. 1 is an exploded perspective view showing a first embodiment of the invention;

FIG. 2 is a plan view as seeing a housing 30 of FIG. 1 from the side of the upper face;

FIG. 3 is a bottom view as seeing the housing 30 of FIG. 1 from the side of the bottom face;

FIG. 4 is a section view of an electroacoustic transducer 1 taken along a line A-A of FIG. 2;

FIGS. 5A to 5F are section views showing a step of insert molding the housing 30, where FIGS. 5A to 5C show a comparative example, and FIGS. 5D to 5F show the embodiment;

FIG. 6 is a section view showing a second embodiment of the invention;

FIG. 7 is a section view showing a third embodiment of the invention;

FIG. 8 is a partial section view showing a fourth embodiment of the invention;

FIGS. 9A and 9B are partial sections view showing a fifth embodiment of the invention, where FIG. 9A shows a step of insert molding the housing 30, and FIG. 9B shows the shape of the housing 30 after molding;

FIGS. 10A and 10B are partial section views showing a sixth embodiment of the invention, where FIG. 10A shows a step of insert molding the housing 30 and FIG. 10B shows the shape of the housing 30 after molding;

FIG. 11 is a perspective view showing a seventh embodiment of the invention; and

FIG. 12 is a graph showing an example of frequency characteristics of sound pressure levels of electroacoustic transducers.

### DETAILED DESCRIPTION OF THE PREFERRED EMBODIMENTS

Now, a description will be given in more detail of preferred embodiments of the invention with reference to the accompanying drawings.

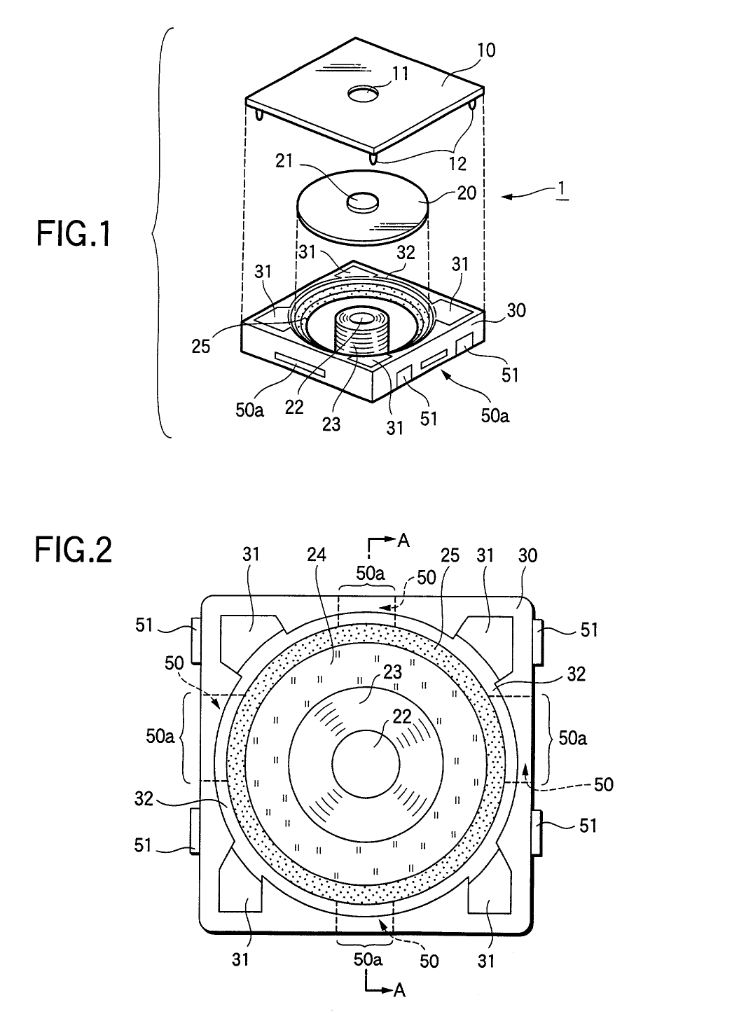

FIG. 1 is an exploded perspective view showing a first embodiment of the invention. In an electroacoustic transducer 1, a top plate 10 having a sound hole 11 is fixed onto a box-like housing 30 configured by a flat rectangular cylindrical member. For example, the transducer has dimensions of a width of 7. 5 mm×a depth of 7.5 mm×a height of 3 mm.

A columnar magnetic core 22 upstands from the center of the housing 30. A coil 23 is wound around the magnetic core 22. An annular magnet 25 is partly embedded in the inner wall of the housing 30 so as to be placed concentrical with the magnetic core 22. An annular inner space is ensured between the magnet 25 and the coil 23.

An annular supporting step 32 is formed on the upper face of the inner wall of the housing 30. A disk-like diaphragm 20 is horizontally placed on the annular step 32, thereby being positioned in place.

A recess 31 is formed in each of the edges of the upper face of the housing 30. Four protrusions 12 are formed in the edges of the lower face of the top plate 10, respectively. The attaching position of the top plate 10 is restricted by engagement between inner corners of the recess 31 and the protrusions 12.

In a lower portion of the outer wall of the housing 30, four terminals 51 which are to be electrically connected to a circuit board by soldering or the like are disposed. Communication openings 50a through which the inner space of the housing 30 communicates with the outside air are formed in side wall faces 30. The housing 30 and the top plate 10 are formed of a synthetic resin such as a thermoplastic resin.

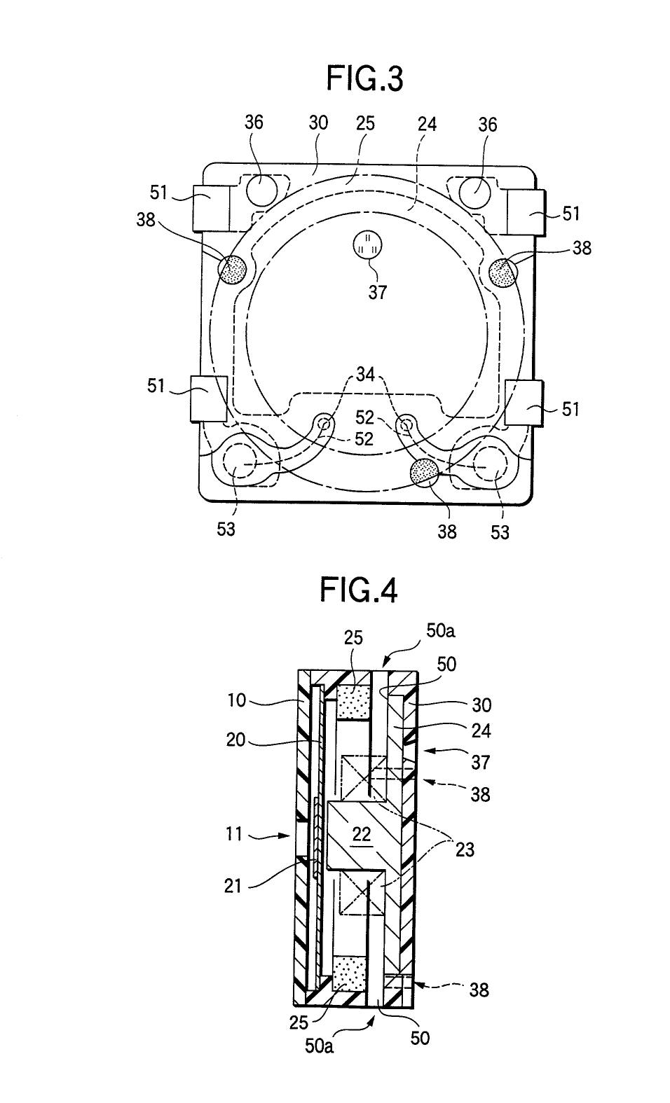

FIG. 2 is a plan view as seeing the housing 30 of FIG. 1 from the side of the upper face, FIG. 3 is a bottom view as seeing the housing 30 of FIG. 1 from the side of the bottom face, and FIG. 4 is a section view of the electroacoustic transducer 1 taken along the line A-A of FIG. 2.

First referring to FIG. 2, the annular step 32 which supports the diaphragm 20 is formed at a position which is slightly lower than the upper face of the housing 30, and the upper face of the annular magnet 25 is positioned at a level which is lower than the step 32. The coil 23 is placed around the magnetic core 22 at the center of the housing. The plate-like base 24 is placed below the magnetic core 22, the coil 23, and the magnet 25. The peripheral portion of the base 24 is partly embedded in the inner wall of the housing 30.

Communication paths 50 which respectively extend from the back space of the diaphragm 20 to the communication openings 50a are formed in the side wall of the housing 30.

Next referring to FIG. 3, a cutaway hole 37 through which the base 24 is partly exposed is formed in the bottom face of the housing.

The terminals 51 are partly embedded in the edges of the bottom face of the housing 30. The embedded portions of the upper two terminals 51 are partly exposed through cutaway holes 36, respectively. The lower two terminals 51 are halfway embedded in the housing 30, and exposed also in the vicinity of the edges of the bottom face. Lead wires 52 of the coil 23 are drawn out to the outside via through holes 34 of the housing 30, and then electrically connected to the exposed portions of the lower two terminals 51 by soldering 53. The through holes 34 are sealed by a mold material such as a synthetic resin or the like for attaining air tightness and dust proofness. The lower two terminals 51 serve as terminals for supplying a driving signal to the coil 23, and the upper two terminals 51 serve as terminals for reinforcement.

In the bottom face of the housing, three cutaway holes 38 are formed so as to divide approximately equally the circumference of the magnet 25 into three portions, and the bottom face of the magnet 25 is partly exposed.

The plan-view shape of the base 24 has a portion which elongates more outwardly than the width center of the magnet 25, i.e., the intermediate radius Rc (=(Ra+Rb)/2) of the inner radius Ra and the outer radius Rb so that, as seeing from the side of the bottom face, the overlapping area between the bottom face of the magnet 25 and the base is increased as largely as possible while avoiding the terminals 51, the cutaway holes 38, and the through holes 34. This shape of the base enhances the magnetic coupling between the base 24 and the magnet 25, so that the conversion efficiency and the sound pressure level can be maintained at a high level.

Next referring to FIG. 4, the base 24 which is made of a magnetic material is embedded in the inner bottom face of the housing 30, and the magnetic core 22 which is made of a magnetic material upstands from the base 24. Alternatively, the magnetic core 22 and the base 24 may be integrated with each other so as to be configured as a single pole-piece member.

The diaphragm 20 made of a magnetic material is supported at the peripheral edge portion by the upper face of the inner wall of the housing 30, and a constant gap is ensured between the center of the bottom face of the diaphragm 20 and the tip end of the magnetic core 22. A disk-like magnetic piece 21 is fixed to the center of the upper face of the diaphragm 20 so as to increase the mass of the diaphragm 20, thereby improving the efficiency of vibrating the air.

The magnet 25 is embedded in the inner wall of the housing 30 with being separated by a constant distance from the peripheral edge portion of the base 24. The magnet 25 is magnetized in the thickness direction. When the bottom face of the magnet 25 is magnetized to the N-pole and the upper face to the S-pole, for example, lines of magnetic force emerging from the bottom face of the magnet 25 pass through a route of the peripheral edge portion of the base 24→a center portion of the base 24→the magnetic core 22→a center portion of the diaphragm 20→a peripheral edge portion of the diaphragm 20 →the upper face of the magnet 25, so as to configure a closed magnetic circuit as a whole. The magnet 25 has a function of supplying a static magnetic field to the magnetic circuit. The diaphragm 20 is stably supported in a state where the diaphragm is attracted toward the magnetic core 22 and the magnet 25 by the static magnetic field.

When an electric oscillating signal is supplied from the circuit board to the coil 23 wound around the magnetic core 22 via the lower two terminals 51 and the lead wires 52, the coil supplies an oscillating magnetic field to the magnetic circuit. Then, the oscillating magnetic field is superimposed on the static magnetic field, whereby the diaphragm 20 is vibrated. As a result, the air on the side of the upper face of the diaphragm 20, and that on the side of the bottom face are vibrated.

The side of the upper face of the diaphragm 20 cooperates with the top plate 10 to form a resonance chamber. When the vibration frequency of the diaphragm 20 substantially coincides with the resonance frequency of the resonance chamber, a sound of a high sound pressure level is generated, and the sound is emitted to the outside through the sound hole 11.

The sound generated on the side of the back face of the diaphragm 20 is opposite in phase to the sound on the side of the front face, and hence interference with the sound on the side of the front face must be suppressed as far as possible. To comply with this, the sound on the side of the back face of the diaphragm 20 is emitted from the side wall faces of the housing 30 to the outside via the annular inner space of the housing 30, the communication paths 50, and the communication openings 50a. In this way, the formation of the communication paths 50 in the side wall of the housing 30 prevents the communication openings 50a not to be closed even in a state where the bottom face of the transducer is closely mounted on a circuit board. Therefore, the mounting height can be reduced.

Since the magnet 25 is placed with being separated from the base 24 by the predetermined distance and the communication paths 50 are disposed between them, it is possible to ensure the communication paths 50 which have a large sectional area and a small acoustic impedance. Therefore, the air damping effect in the back space of the diaphragm 20 can be efficiently lowered, so that it is possible to realize an electroacoustic transducer which is small in size and produces a high sound pressure.

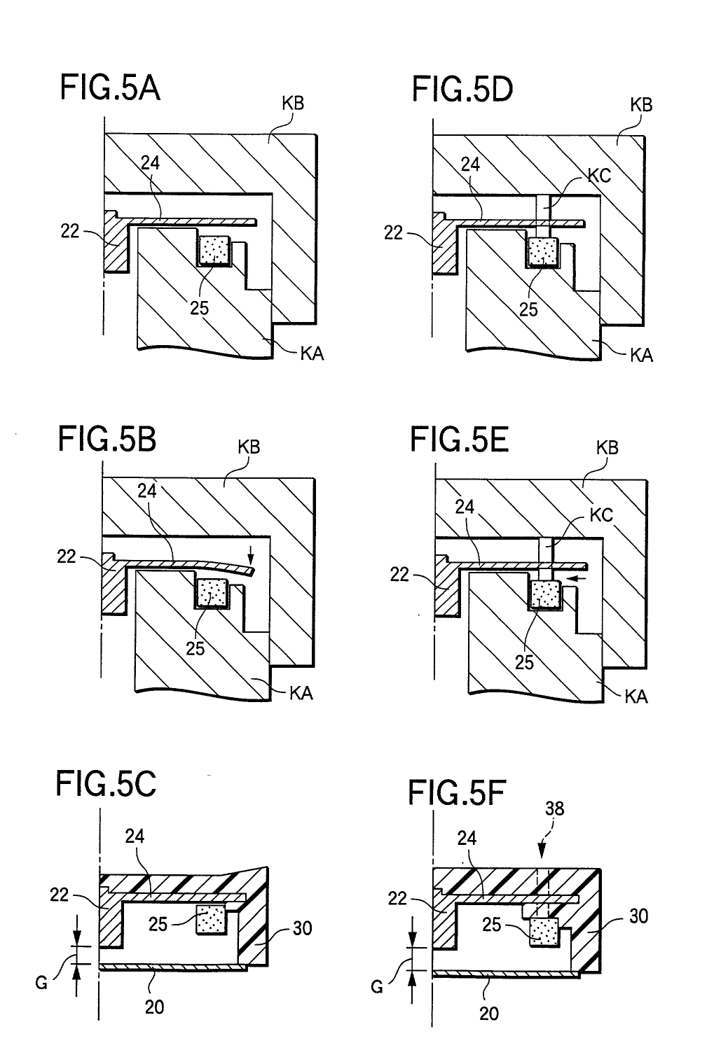

FIGS. 5A to 5F are section views showing a step of insert molding the housing 30, FIGS. 5A to 5C show a comparative example, and FIGS. 5D to 5F show the embodiment. First referring to FIG. 5A, the molding face of a molding die KA is shaped so as to correspond to the upper face and the inner wall of the housing 30, and that of a molding die KB is shaped so as to correspond to the outer wall of the housing 30. The shape of the space between the molding dies KA and KB corresponds to that of the housing 30.

The molding face of the molding die KA is formed into a shape which enables the magnetic core 22 and the base 24 to be positioned, and the non-magnetized magnet 25 to be positioned. The gap between the non-magnetized magnet 25 and the base 24 is set to be very small or about 0 to 0.08 mm. When the non-magnetized magnet 25 is made of a sintered material such as ferrite, the thickness tends to be substantially varied. Therefore, the thickness of the magnet may be insufficient. In this case, the gap between the magnet and the base 24 is increased. When the thickness of the magnet is excessive, the base 24 is pushed up, so that the magnet is broken or the base is deformed during the molding process.

Next referring to FIG. 5B, when a synthetic resin is injected into the mold space, the resin hardly enters the gap between the non-magnetized magnet 25 and the base 24 because of the viscosity of the resin. When the resin injection pressure presses the base 24 toward the magnet, the presence of the gap causes the base 24 to be deformed by a distance corresponding to the gap. The resin is then solidified under this state.

After the resin is solidified, steps such as those of magnetizing the magnet 25, treating the coil lead wires 52, mounting the diaphragm 20, and attaching the top plate 10 are conducted to complete the electroacoustic transducer 1. Thereafter, the electroacoustic transducer 1 is mounted on the circuit board by solder reflow or the like. In this case, the stress of the base 24 is released by heating in the reflow, thereby causing so-called spring back. As shown in FIG. 5C, then, the outer peripheral portion of the housing 30 is warped toward the bottom face, and the step 32 which supports the diaphragm 20 is displaced toward the bottom face. As a result, the gap G between the diaphragm 20 and the magnetic core 22 is reduced to be smaller than a target value, and the characteristics of the electroacoustic transducer 1 are largely changed. The amount of the spring back mainly depends on the thickness of the magnet.

As a countermeasure against such spring back, as shown in FIG. 5D, press pins KC are disposed on the molding die KB to press the non-magnetized magnet in the direction from the base 24 to the molding die KA. In order to allow the resin to easily flow into the gap between the non-magnetized magnet 25 and the base 24, the gap is set to be relatively wide or about 0.4 mm.

Next referring to FIG. 5E, when the synthetic resin is injected into the mold space under this state, a sufficient amount of the synthetic resin flows also into the gap between the non-magnetized magnet 25 and the base 24, and hence the resin injection pressure is uniformly applied to both the faces of the base 24, thereby preventing the base 24 from being deformed. Since the non-magnetized magnet 25 is positioned by the press pins KC, it is possible to prevent the non-magnetized magnet 25 from being raised or displaced.

After the resin is solidified, the magnet 25 is detached from the molding dies. Then, steps such as those of magnetizing the magnet 25, treating the coil lead wires 52, mounting the diaphragm 20, and attaching the top plate 10 are conducted to complete the electroacoustic transducer 1 shown in FIG. 5F. As a result, even when the transducer is heated by solder reflow or the like, spring back does not occur because the residual stress of the base 24 is substantially zero. Therefore, the gap G between the diaphragm 20 and the magnetic core 22 coincides with the target value. Consequently, positional accuracies of the magnet 25, the base 24, and the other components can be remarkably improved, and characteristics of a final product can be stabilized.

When the structure in which the housing 30 is interposed between the magnet 25 and the base 24 is employed as described above, the base 24 is prevented from being deformed during the process of injecting the resin, and hence influences of spring back can be eliminated. As a result, positional accuracies among the components, particularly, the dimensional accuracy of the gap G between the diaphragm 20 and the magnetic core 22 can be maintained at a high level, and a high efficiency and stable characteristics can be obtained. Even when the thickness of the magnet is varied, a large influence is not exerted because the gap between the non-magnetized magnet 25 and the base 24 is wide.

Preferably, the plan-view shape of the base 24 remains to be inside the outer periphery of the magnet 25 as shown in FIG. 3, so as to have a shape which does not protrude from the outer periphery of the magnet toward the outside. According to this configuration, the resin can easily enter the gap between the magnet 25 and the base 24, so that deformation of the base 24 due to the resin injection pressure is prevented as far as possible from occurring, while ensuring a high magnetic coupling.

Preferably, the press pins KC are detachably disposed on the molding die. When the thickness of the magnet is changed to another value in accordance with specifications of a final product, this change can be coped with by replacing the pins with other press pins of a different restricting position.

As shown in FIGS. 3 and 4, cavities of the press pins KC are formed as the cutaway holes 38. Furthermore, also press pins which are to be used for positioning the base 24 and the upper two terminals 51 in the step of insert molding the housing 30 may be disposed on the die. The cavities of these press pins are formed as the cutaway holes 36 and 37.

Since the magnet 25, the base 24, and the terminals 51 are partly exposed through the cutaway holes 36 to 38, there arises an advantage that quality management such as positioning of the components, and measurement of the positions can be easily conducted in steps of assembling and checking the electroacoustic transducer.

The cutaway holes 36 to 38 may remain as they are. In this case, no problem will be produced in operation. Alternatively, a step of filling the cutaway holes 36 to 38 with a filler such as a synthetic resin (preferably, the same material as that of the housing 30) may be added. In the alternative, characteristics of a final product such as air tightness and durability can be improved.

In the above, an example in which a non-magnetized magnet is used as the magnet that is to be inserted during a process of molding the housing has been described. Alternatively, in the case where molding dies made of a non-magnetic material such as aluminum are used, a magnetized magnet may be used.

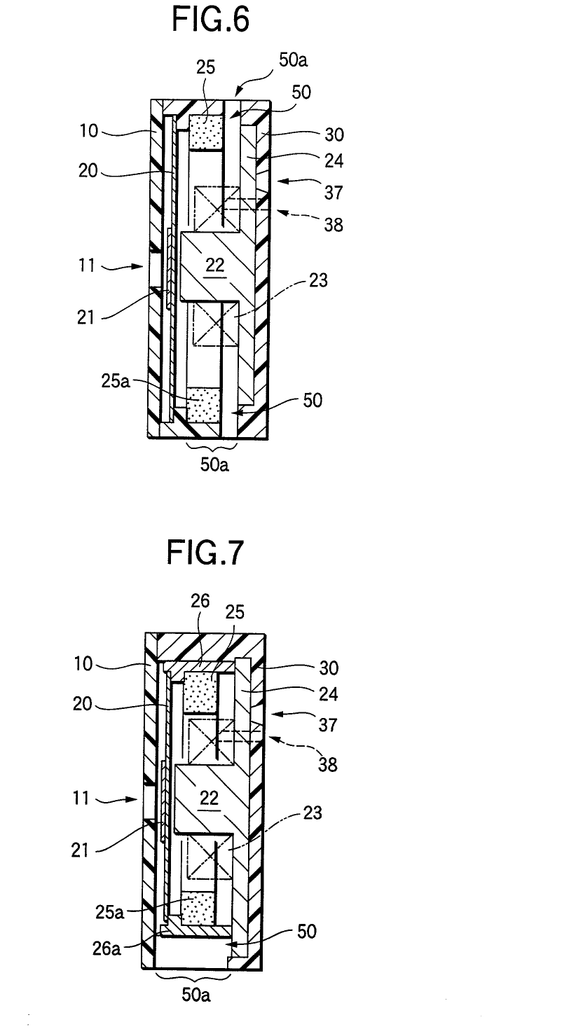

FIG. 6 is a section view showing a second embodiment of the invention. The whole configuration of the embodiment is identical with that shown in FIGS. 1 to 4 except that the annular magnet 25 is partly cut away to be formed into a C-like shape and the communication path 50 is formed in the side wall of the housing 30 so as to pass through the cutaway portion 25a.

When the cutaway portion 25a is formed in the magnet 25 as described above, it is possible to ensure the communication path 50 which has a large sectional area and a small acoustic impedance. Therefore, the air damping effect in the back space of the diaphragm 20 can be efficiently lowered, so that it is possible to realize an electroacoustic transducer which is small in size and produces a high sound pressure.

FIG. 7 is a section view showing a third embodiment of the invention. The whole configuration of the embodiment is identical with that shown in FIGS. 1 to 4 except that an annular support ring 26 for supporting the peripheral edge portion of the diaphragm 20 is placed around the magnet 25, the annular magnet 25 and the annular support ring 26 are partly cut away to be formed into a C-like shape, and the communication path 50 is formed in the side wall of the housing 30 so as to pass through the cutaway portions 25a and 26a.

When the cutaway portions 25a and 26a are formed in the magnet 25 and the annular support ring 26 as described above, it is possible to ensure the communication path 50 which has a large sectional area and a small acoustic impedance. Therefore, the air damping effect in the back space of the diaphragm 20 can be efficiently lowered, so that it is possible to realize an electroacoustic transducer which is small in size and produces a high sound pressure.

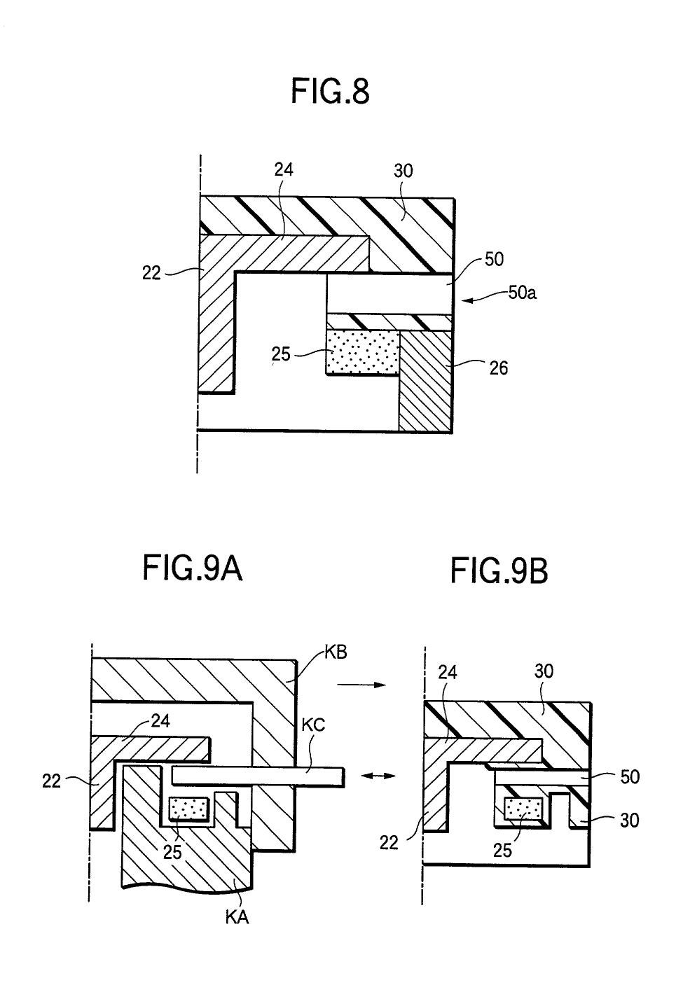

FIG. 8 is a partial section view showing a fourth embodiment of the invention. The whole configuration of the embodiment is identical with that shown in FIG. 7 except that the housing 30 is not integrated with the magnet 25 and the support ring 26 but these components are fixed by an adhesive agent.

The base 24 is embedded in the inner bottom face of the housing 30, and the magnetic core 22 upstands from the base 24. The communication path 50 which is in parallel with the inner face of the baser 24 is formed in the side wall of the housing 30 so as to pass between the base 24, and the magnet 25 and the support ring 26. Also in this configuration, the air damping effect in the back space of the diaphragm 20 can be efficiently lowered, so that it is possible to realize an electroacoustic transducer which is small in size and produces a high sound pressure.

FIGS. 9A and 9B are partial section views showing a fifth embodiment of the invention, where FIG. 9A shows a step of insert molding the housing 30, and FIG. 9B shows the shape of the housing 30 after molding. The molding face of a molding die KA is shaped so as to correspond to the upper face and the inner wall of the housing 30, and that of a molding die KB is shaped so as to correspond to the outer wall of the housing 30. The shape of the space between the molding dies KA and KB corresponds to that of the housing 30. A slide core KC is slidably inserted into a through hole formed in the side face of the molding die KA, to form a shape corresponding to the communication path 50 which is to be formed in the side wall of the housing 30.

As shown in FIG. 9B, the housing 30 after molding is shaped so that the communication path 50 is formed in the side wall of the housing 30 so as to pass between the base 24 and the magnet 25. Also in this configuration, the air damping effect in the back space of the diaphragm 20 can be efficiently lowered, so that it is possible to realize an electroacoustic transducer which is small in size and produces a high sound pressure.

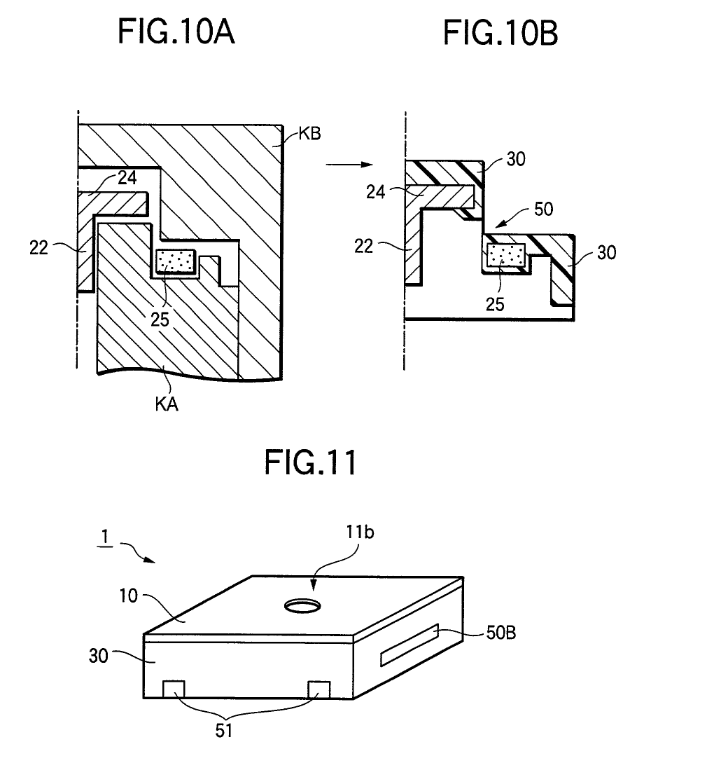

FIGS. 10A and 10B are partial section views showing a sixth embodiment of the invention, where FIG. 10A shows a step of insert molding the housing 30, and FIG. 10B shows the shape of the housing 30 after molding. The molding face of a molding die KA is shaped so as to correspond to the upper face and the inner wall of the housing 30, and that of a molding die KB is shaped so as to correspond to the outer wall of the housing 30. The shape of the space between the molding dies KA and KB corresponds to that of the housing 30. In the embodiment, in place of the slide core KC, the base 24 is partly cut away to ensure a portion in which the molding dies KA and KB make in contact with each other, between the base 24 and the magnet 25, thereby forming the shape of the communication path 50.

As shown in FIG. 10B, the housing 30 after molding is shaped so that the communication path 50 is formed in the side wall of the housing 30 on the side of the step so as to pass between the base 24 and the magnet 25. Also in this configuration, the air damping effect in the back space of the diaphragm 20 can be efficiently lowered, so that it is possible to realize an electroacoustic transducer which is small in size and produces a high sound pressure.

FIG. 11 is a perspective view showing a seventh embodiment of the invention. In the above, the configuration has been described in which the sound radiated through the sound hole 11 formed in the top plate 10 is used, and the air damping pressure of the diaphragm 20 is released through the communication opening 50a formed in the side face of the housing 30. By contrast, in the embodiment, a back sound radiated through a communication opening 50b is positively used, and the air damping pressure of the diaphragm 20 is released through a sound hole 11b formed in the top plate 10. Alternatively, a configuration in which the sound hole 11b is completely sealed by a sealing agent or the like may be employed as required.

According to this configuration, a front sound or a back sound can be selectively used without changing the structure of the transducer, and hence it is possible to cope with various ways of mounting a transducer on a circuit board.

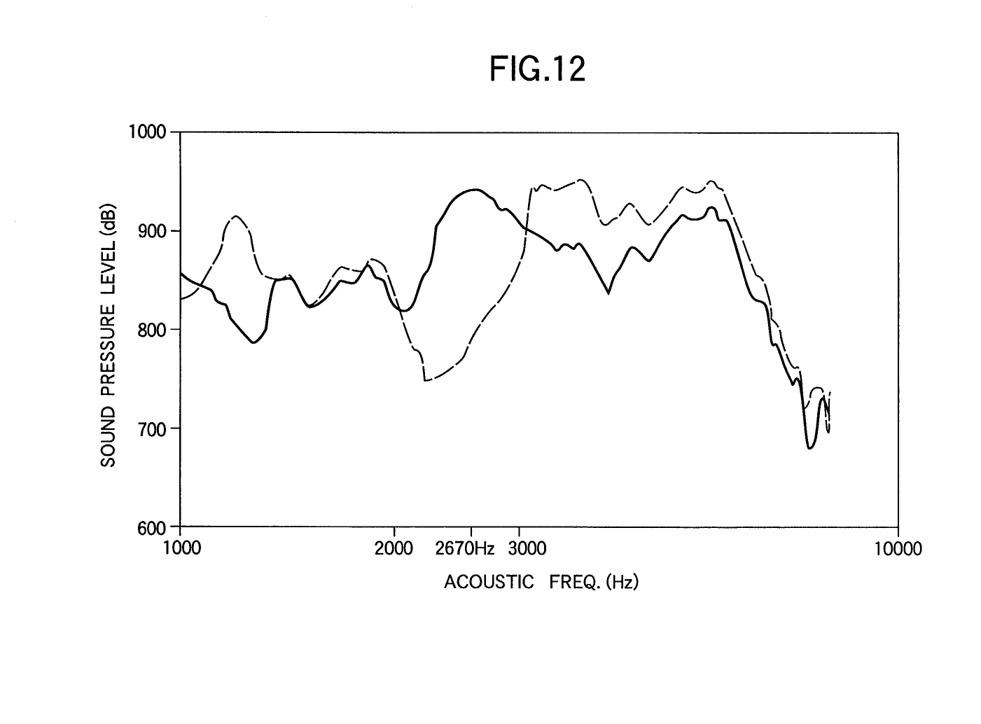

FIG. 12 is a graph showing an example of frequency characteristics of sound pressure levels of electroacoustic transducers. In the graph, the abscissa indicates the acoustic frequency (Hz), and the ordinate indicates the sound pressure level (dB). The solid line shows the case where a side opening is formed (the invention), and the broken line shows the case where a side opening is not formed (a comparative example). As seen from the curve of the solid line, the resonance frequency f0 is about 2,670 Hz. By contrast, as seen from the curve of the broken line, the resonance frequency f0 is shifted toward the high frequency side, or about 3,500 Hz. The resonance frequency f0 and the frequency characteristics can be changed by adjusting the shape of the side communication path. Therefore, it is possible to easily cope with changes of specifications of a final product.

As described above in detail, according to the invention, a communication path through which a back space of the diaphragm communicates with the outside is formed in a side face portion of the body of the transducer or the housing member, and hence the communication opening is not closed even in a state where the bottom face of the transducer is closely mounted on a circuit board. As compared with a case where a communication opening is formed in the bottom face of a transducer as in the conventional art, therefore, the mounting height can be reduced.

When the magnet is placed with being separated from the base member by a predetermined distance or a cutaway portion is formed in the magnet and the support ring member, it is possible to ensure a communication path which has a large sectional area and a small acoustic impedance. Therefore, the air damping effect in the back space of the diaphragm can be efficiently lowered, so that it is possible to realize an electroacoustic transducer which is small in size and produces a high sound pressure.

What is claimed is:

1. An electroacoustic transducer comprising:
a plate-like base member made of a magnetic material;
a magnetic core made of a magnetic material and upstanding on said base member;
a diaphragm made of a magnetic material and supported with being separated from a tip end of said magnetic core by a gap;
a magnet which cooperates with said base member, said magnetic core and said diaphragm to constitute a magnetic circuit and which supplies a static magnetic field; and
a coil placed around said magnetic core and supplying an oscillating magnetic field to said magnetic circuit;
wherein a communication path through which a back space of said diaphragm communicates with an outside is formed in a side face portion of a body of said transducer, and said communication path passes between said base member and said magnet.

2. An electroacoustic transducer comprising:
a plate-like base member made of a magnetic material;
a magnetic core made of a magnetic material and upstanding on said base member;
a diaphragm made of a magnetic material and supported with being separated from a tip end of said magnetic core by a gap;
a magnet which cooperates with said base member, said magnetic core and said diaphragm to constitute a magnetic circuit and which supplies a static magnetic field;
a coil placed around said magnetic core and supplying an oscillating magnetic field to said magnetic circuit; and
a housing member formed integrally with said base member and said magnet;
wherein a communication path through which a back space of said diaphragm communicates with an outside is formed in a side face portion of said housing member.

3. An electroacoustic transducer according to claim 2, wherein said communication path passes between said base member and said magnet.

4. An electroacoustic transducer according to claim 1 or 2, wherein said communication path passes through a cutaway portion of said magnet.

5. An electroacoustic transducer according to claim 1 or 2, wherein said transducer further comprises a supporting member which is placed around said magnet, and which supports a peripheral edge portion of said diaphragm; and
wherein said communication path passes through a cutaway portion of said magnet and a cutaway portion of said supporting member.
